(19) United States
(12) Patent Application Publication
(10) Pub. No.: US 2011/0318003 A1
(43) Pub. Date: Dec. 29, 2011

(54) OPTICAL SWITCHING AND TERMINATION APPARATUS AND METHODS

(76) Inventor: Paul D. Brooks, Weddington, NC (US)

(21) Appl. No.: 12/823,033

(22) Filed: Jun. 24, 2010

(51) Int. Cl. H04J 14/00

(52) U.S. Cl. 398/45

(57) ABSTRACT

Methods and apparatus for selective subscriber service connect and disconnect in a fiber-optic network. In one embodiment, disconnect is achieved by the purposeful use of signal attenuation due to macrobending losses within the optical fiber. In another embodiment, the macrobending optical switch apparatus is used to merely decrease signal intensity to the point where the value of the service cannot be received. In a further embodiment, the macrobending signal loss is used to protect the network from unwanted interference signals that may disturb the network operation. In another embodiment, the macrobending switch apparatus is used to selectively induce chromatic dispersion within one or more wavelengths of light being carried on the fiber, thereby providing for range-selective service disconnect or denial. Optical multiplexer apparatus is also utilized to remotely connect ore reconnect service to selected subscriber premises or network nodes.

### RELATED APPLICATIONS

This application is related to co-owned, co-pending U.S. patent application Ser. No. 12/732,859 filed on Mar. 26, 2010 and entitled “FIBER TO THE PREMISES SERVICE DISCONNECT VIA MACRO-BLENDING LOSS”, which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of Invention

The present invention relates generally to the field of fiber optic data delivery, such as for example fiber-to-the-premises content delivery, broadband Internet networks, or cable telecommunications. More specifically, the present invention relates in one exemplary aspect to methods and apparatus for fiber optic network termination and subscriber service disconnect and reconnection.

2. Description of Related Technology

Fiber optic networks transmit information utilizing light pulses propagating through optical conduits (such ads optical fiber). The light forms an electromagnetic carrier wave that is modulated to carry information. First developed in the 1970s, fiber-optic communication systems have revolutionized the telecommunications industry and have played a major role in the advent of the Information Age. Because of its advantages over electrical transmission, optical fibers have largely replaced copper wire communications in core networks in the developed world.

The process of communicating using fiber-optics involves the following basic steps: (i) creating the optical signal involving the use of a transmitter; (ii) relaying the signal along the optical conduit (fiber), ensuring that the signal does not become too distorted or weak; (iii) receiving the optical signal; and (iv) converting the received optical signal into an electrical signal.

### Optical Fiber

An optical fiber cable is a cable containing one or more optical fibers. The optical fiber elements are typically individually coated with plastic layers and contained in a protective tube suitable for the environment where the cable will be deployed.

An optical fiber is a dielectric waveguide typically made of glass or plastic consisting of a core, cladding and a sheath or jacket. The index of refraction of the assembly varies across the radius of the cable: the core possesses a high refractive index, whereas the cladding is constructed to have a lower refractive index. The result of the difference in the refractive indexes is to keep light flowing through the core after it gets into the core, by way of total internal reflection, even if the fiber is bent or tied into a knot, through total internal reflection.

As light pulses travel through the fiber they undergo scattering, reflections and refractions which result in loss of optical power, hereinafter referred to as attenuation. One loss mechanism of interest is attenuation due to bending of the fiber, more specifically macrobending. In the field of fiber optics, the term “macrobending” is typically used to describe fiber bends with a radius of curvature that is larger than the fiber diameter. When the bend ratio, defined as the bending radius divided by the fiber radius, exceeds a specified number (determined by the susceptibility of the fiber to macrobending losses and given in the fiber spec) macrobending losses become substantial (the loss will depend on the length and radius) and may attenuate light signal below levels required for successful detection by optical receiving apparatus. Generally, an amount of optical loss on the order of 20 dB is sufficient for service denial.

To mitigate these negative effects of macrobending signal loss, great effort has been directed by fiber optic cable manufacturers at the development of materials and manufacturing methods that reduce macrobending losses in the optic fiber. For example, U.S. Patent Publication No. 20080285927 (published Nov. 20, 2008) describes a method for manufacturing an optical fiber having uniform refractive index profile, and substantially reduced macrobending loss and attenuation loss by controlling concentration of dopant in the outer region and the inner region of the core. U.S. Pat. No. 7,433,566 issued Oct. 7, 2008 describes an optical fiber with a low loss achieved by applying a coating surrounding and in direct contact with the silica-based cladding region of the fiber.

Another loss mechanism is commonly referred to as “microbending”, wherein an external clamping mechanism is attached over a short portion (about few inches) of the fiber optic cable to induce periodic microbends in the fiber, thus forcing some of the light signal energy carried by the fiber to be lost, e.g., by radiation peripherally out of the fiber. See, e.g., U.S. Pat. No. 4,749,248 issued Jun. 7, 1988 and U.S. Pat. No. 6,542,689 issued Apr. 1, 2003. Both of these patents disclose clamp-on devices in the form of opposed, corrugated plates that are clamped about a fiber to achieve a periodic axial distortion of the fiber for purposes of mode coupling.

Two main types of optical fiber used in fiber optic communications include multi-mode optical fibers and single-mode optical fibers. A multi-mode optical fiber typically has a larger core (=50 micrometers), allowing less precise, less expensive transmitters and receivers to connect to it, as well as use of less costly connectors. However, a multi-mode fiber introduces multimode distortion, which often limits the bandwidth and length of the link. Furthermore, because of its higher dopant content, multimode fibers are usually comparatively expensive and exhibit higher attenuation. The core of a single-mode fiber is smaller (typically <10 micrometers) and requires more expensive components and interconnection methods, but allows much longer, higher-performance links.

### Optical Fiber Networks

Optical fiber is widely used by telecommunications companies to deliver telephone services, Internet communication, cable television signals, etc. Due to much lower attenuation as a function of range and lower susceptibility to electromagnetic interference, optical fiber offers substantial advantages compared to copper wire in long-distance and high data throughput (bandwidth) applications. However, infrastructure development within cities was relatively difficult and time-consuming, and fiber-optic systems were complex and expensive to install and operate. Due to these difficulties, fiber-optic communication systems initially have primarily been installed in long-distance applications, where they offer a substantial increase in the network transmission capacity, offsetting the additional cost.

As the cost of fiber-optic communication equipment and fiber dropped, the demand for high data rate services grew. These high data rate (bandwidth) services and functions include digital broadcast programming (movies, etc.), digital video-on-demand (VOD), personal video recorder (PVR), Internet Protocol television (IPTV), digital media playback and recording, as well high speed Internet access and IP-based telephony (e.g., VoIP). Other services available to network users include access to and recording of digital music (e.g., MP3 files), remote security and surveillance, as well local area networking (including wire-line and wireless local area networks) for distributing these services throughout the user's premises, and beyond.

In order to facilitate the proliferation of these data-intensive applications, telecommunications providers are eliminating the copper wiring that typically links groups of businesses and residences to these centrally located fiber-optic networks, and extending the optical fiber all the way to individual commercial locations and homes, closer to the network edge. These optical fiber distribution networks typically are known as “Fiber-to-the-X” or FTTx (which may include for example FiOS, FTTP, FTTH, FTTC, FTTN, and FTTB, and variants thereof), and allow for the high data bandwidth services to be delivered in one package with far greater speed, clarity and reliability. The actual speed depends on the equipment terminated on each end of the link, but may be on the order of 10 Mbps, 100 Mbps or even 1 Gbit/s using currently available technologies. Consumers are consequently able to download or upload music, movies, and data much faster.

Network configurations that bring fiber into the end-user's premises can offer the highest speeds. However, such “FTTP” network deployment requires substantial additional capital and ongoing investment in order to enable optical fiber interconnections at both the communications facilities side, as well as the premises side. In order to reduce equipment deployments in communications facilities and conserve fiber optic resources on communications routes, thereby conserving capital, service providers are deploying FTTP networks using partial penetration designs. That is, additional equipment is installed based on the actual (or near-term projections) of high data rate subscriptions growth. This approach is efficient in that only a portion of the facilities' optronics and route fiber counts are required, since this equipment and cabling scales somewhat linearly with service uptake rates. While this deployment approach reduces equipment expenditures it, however, results in a need for complex network connections reconfigurations that are typically accomplished by dispatching service vehicles and personnel to the premises locations to perform equipment installation and hook up, as the customers churn-in and churn-out and high data bandwidth service uptake rates move up and down over time.

Fiber-To-The-Premises (FTTP) networks (aka Passive Optical or “PON” Networks) typically employ a single strand of optical fiber originating at the service provider's facility (end-office, distribution hub, outdoor enclosure, etc). This single strand of fiber (or single wavelength within the strand) connects the facility to the proximate location of, and provides connectivity to, multiple subscribers (e.g., residences or businesses). Optical signals to and from this group of subscribers share the optical connection to the service provider. This topology is commonly referred to as “tree and branch.” A tree and branch topology is favored for this application because it conserves expensive fiber resources for the “backhaul” portion of the network through the sharing of the fiber strand (or sharing of a wavelength within the strand). It is distinct from the “star” topology, which requires either a dedicated fiber strand all the way from the facility to the customer, or a dedicated wavelength within that strand.

Although the tree and branch topology is favored in the majority of today's FTTP deployments, an important disadvantage is that it is not possible to physically disconnect service to an individual subscriber at the facility end of the connection. Some type of access control is also necessary to prevent service theft. When physical disconnection is used as the access control method, it has the additional advantage of preventing unauthorized and/or malicious injection of signals into the network. This has not been a major concern because of the following reasons. Specifically, FTTP networks that exclusively use digital baseband modulation (OOK or variants such as QPSK or QAM) can perform a service disconnect merely by de-authorizing operator-owned or managed subscriber premises equipment. This access control method, however, still leaves the network open to malicious injection of interfering optical signals, although the fixed location of the interference source simplifies discovery and remediation of any attack. Moreover, FTTP networks that employ linear analog modulation, either in the downstream only direction (some variants of GPON) or in both directions (RFoG), are susceptible to both theft of service and unauthorized and/or malicious signal injection. However, the difficulty of the hook-up and general unavailability of compatible terminal equipment has provided a de facto barrier to both.

Because of concerns relating to the existence of only a temporary barrier for linear analog modulation systems, deployments of FTTP networks that provide service using linear analog modulation typically use a physical service disconnect at a location proximate to the subscriber. This physical disconnect generally employs an optical connector, but may also be accomplished by cutting the fiber strand at a point in the network where the strand feeds only one subscriber.

There are disadvantages to either of these approaches. Connecting two optical fibers is performed by fusion splicing or mechanical splicing, and requires special skills and interconnection technology due to the microscopic precision required to align the fiber cores which is both expensive and time consuming. Moreover, each splice region introduces inhomogeneities in the refractive index in the path the traveling light, which results in additional losses due to scattering and reflection as the light passes through the fusion/interface region.

Splicing is often augmented by the use of fiber optic connectors that are expensive to provide and install, are prone to contamination and damage, and require labor-intensive installation. As a result, both connectors and splices have reliability concerns.

Accordingly, there is a salient need for methods and apparatus to perform on-demand switching and or service disconnect by the service provider. Specifically, methods and apparatus are needed for connection and disconnection of subscriber fibers and optronic equipment without the use of fiber splicing, and or optical connectors that break the integrity of the fiber optic cable. Exemplary methods and apparatus would additionally provide a mechanism for optical switching on and off of network optical devices.

### SUMMARY OF THE INVENTION

The present invention addresses the foregoing needs by providing methods and apparatus for fiber optic network on-demand switching and or service disconnect by the service provider.

In a first aspect of the invention, network switching apparatus is disclosed, In one embodiment, the apparatus is configured to selectively vary a bend radius of an optical conduit, the variation attenuating one or more optical transmissions through the conduit to effect switching form a first mode to a second mode.

In one variant, the conduit comprises a single-mode optical fiber, and the second mode comprises attenuating the one or more optical transmissions so as to substantially frustrate the optical transmissions being utilized a downstream network node.

Alternatively, the second mode comprises inducing chromatic dispersion within the pulses of the one or more optical transmissions so as to substantially frustrate the optical transmissions being utilized a downstream network node.

In another variant, the switching apparatus comprises a plurality of rollers configured to move at least a portion of the conduit in a direction substantially perpendicular to a longitudinal dimension of the conduit. A driver apparatus may also be operatively coupled to at least a portion of the plurality of rollers and configured to effect movement of the at least portion of the rollers. A plurality of fixed rollers may also be disposed proximate to the plurality of rollers configured to move, the fixed rollers configured to substantially block at least a portion of the conduit.

In still another variant, the switching apparatus comprises at least two pairs of rollers, the pairs of rollers configured to move in substantially opposite directions from each other along an axis that is substantially perpendicular to a longitudinal dimension of the conduit.

Alternatively, the switching apparatus comprises a post of a varying diameter, defining at least a first radius and a second radius, and adapted for the conduit to move between the first radius and the second radius.

As yet another alternative, the switching apparatus comprises at least two posts configured to receive at least a portion of the conduit such that when the conduit is disposed on the at least two posts, at least a portion of the conduit assumes a radius that substantially attenuates at least a portion of the one or more optical transmissions. A remote controller apparatus is optionally coupled to the driver apparatus and configured to receive commands; and the driver apparatus is further configured to move the plurality of rollers in response to the commands.

In yet another variant, the one or more optical transmissions further comprise a plurality of frequency bands, wherein the switching comprises attenuating so as to selectively frustrate optical transmission to a downstream network node in one or more selected ones of the plurality of frequency bands.

In a second aspect of the invention, apparatus configured to selectively attenuate optical transmissions through a conduit is disclosed. In one embodiment, the apparatus comprises: an optical conduit, at least a portion of the conduit routed through the apparatus; and apparatus configured to selectively vary a bend radius of the optical conduit so as to effect the attenuation.

The conduit comprises e.g., a single-mode optical fiber, or alternatively a multiple mode optical fiber. In the multi-mode fiber case, the selective attenuation substantially attenuates the optical transmissions of at least one mode from multiple modes being carried in the fiber.

In another variant, the optical transmissions comprise a plurality of frequency bands, and the selective attenuation selectively attenuates the optical transmissions within one of the plurality of frequency bands. (e.g., substantially frustrating receipt of the optical transmission at a downstream network node).

In a third aspect of the invention, apparatus for use in network having fiber optic transmission is disclosed. In one embodiment, the apparatus comprises: a first port adapted to receive at least a portion of an incoming optical fiber; a plurality of output ports; a first apparatus configured to selectively couple the incoming optical fiber to at least one of the plurality output ports; and selectively attenuate optical transmissions delivered through at least one of the plurality output ports; and a second apparatus configured to receive a control signal and to actuate the first apparatus in response thereto, in order to effect the attenuation of optical transmissions delivered through at least one of the plurality of output ports.

In one variant, the apparatus further comprises an optical splitter apparatus configured to multiplex and demultiplex optical transmissions between the first port and the plurality of output ports.

The control signal may be received e.g., received via the incoming optic fiber, or via an external wired or wireless communications channel.

In another variant, the optical transmissions comprise a plurality of frequency bands; and the attenuation comprises energy reduction of the optical transmissions within at least one of the plurality of frequency bands.

In a fourth aspect of the invention, a method of selectively providing service to a plurality of subscribers of a content delivery network is disclosed. In one embodiment, the network comprises an optical conduit, and the method comprises: delivering optical transmissions over the optical conduit, the optical conduit having an apparatus associated therewith, the apparatus being configured to selectively attenuate at least a portion of the optical transmissions; receiving a control signal at the apparatus; and actuating, in response to the receiving the control signal, the apparatus in order to selectively attenuate optical transmissions in the optical conduit downstream from the apparatus.

In one variant, the selective attenuation is achieved by imposing a plurality of bends in the optical conduit.

In another variant, the optical transmissions comprise a plurality of frequency bands, and the attenuation comprises energy reduction of the optical transmissions within at least one of the plurality of frequency bands.

In a fifth aspect of the invention, an optical switching apparatus is disclosed. In one embodiment, the apparatus comprises: first apparatus comprising at least first and second ends and configured to route an optical conduit from the first end to the second end; and at least one movable component configured to move within the first apparatus in at least one dimension. The moveable component is further configured to impose at least one bend in the optical conduit when the component is moved from a first position to a second position, thereby inducing macrobending of the conduit and achieving the optical switching.

In one variant, the first apparatus comprises first and second substantially planar surfaces each having at least one complementary undulation formed therein, and the at least one moveable component causes the at least one of the surfaces to move relative to the other, the movement causing the complementary undulations to induce the macrobending within the conduit.

In a sixth aspect of the invention, apparatus for selectively switching off optical signals delivered over an optical fiber is disclosed. In one embodiment, the apparatus comprises: first apparatus configured to selectively induce chromatic dispersion within the fiber so as to switch off only those signals delivered to a first subset of receivers that are each disposed more than a first optical distance from the apparatus; and second apparatus configured to selectively induce attenuation of one or more frequency bands carried within the fiber so as to switch off signals delivered to both the first subset of receivers, and a second subset of receivers that are each disposed less than the first optical distance from the apparatus.

Other features and advantages of the present invention will immediately be recognized by persons of ordinary skill in the art with reference to the attached drawings and detailed description of exemplary embodiments as given below.

### BRIEF DESCRIPTION OF THE DRAWINGS

Reference is now made to the drawings wherein like numerals refer to like parts throughout.

FIG. 1 is a functional block diagram illustrating a portion of a typical optical delivery network useful with various aspects of the present invention.

FIG. 2 is a functional block diagram illustrating one exemplary embodiment of FTTP network architecture useful with various embodiments of the present invention.

FIG. 3a is a composite top and side elevation view of a dual-mandrel switch for use in macrobending optical switches for service disconnect according to a first embodiment of the present invention.

FIG. 3b is a composite top and side elevation view of a variation of the apparatus of FIG. 3a, making use of smaller diameter mandrels and different mandrel spacing.

FIG. 4 is a composite top and side elevation view of illustrates a two peg mandrel for use in macrobending optical switches for service disconnect according to an embodiment of the present invention. Different peg diameter and spacing results in a different bending radii producing different amount of light attenuation.

FIG. 5a is a side elevation view illustrating a switching apparatus comprising a single cylindrical mandrel of varying diameter and optical fiber wound in a figure-eight pattern for use in service disconnect according to an embodiment of the present invention.

FIG. 5b is a side elevation view of another embodiment of the apparatus of FIG. 5a, yet with constant diameter.

FIGS. 6a and 6b illustrate “ON” and “OFF” states respectively, for another embodiment of a macrobending optical switch according the present invention.

FIGS. 7a and 7b illustrates macrobending optical switch according to an alternative embodiment of the present invention. Switching apparatus is shown in the “ON” and “OFF” position, respectively.

FIG. 8 depicts an exemplary coordinate system used to describe fiber bending.

FIG. 9a illustrates mechanized macrobending optical switch comprising a pair of movable rollers in the “ON” position according to another embodiment of the present invention.

FIG. 9b illustrates the switch of the embodiment of FIG. 9a in the “Band 1 OFF” position.

FIG. 9c illustrates the switch of the embodiment of FIG. 9a in the “Bands 1 and 2 OFF” position.

FIG. 9d illustrates another embodiment of the mechanized macrobending optical switch of the invention, comprising a plurality of movable roller pairs.

FIG. 10a illustrates mechanized macrobending optical switch comprising fixed and movable rollers (shown in the in the “ON” position).

FIG. 10b illustrates the switch of FIG. 10a in the “Band 1 OFF” position.

FIG. 10c illustrates the switch of FIG. 10a in the “Band 1 & 2 OFF” position.

FIG. 10d illustrates yet another embodiment of the mechanized macrobending optical switch of the invention, comprising a plurality of alternating fixed and movable rollers.

FIG. 11 illustrates the use of a plurality of a two-peg mandrel macrobending optical switches of FIG. 4a, in a common subscriber connect/disconnect apparatus.

FIG. 12 illustrates the use of a plurality of a mechanized macrobending optical switches of FIG. 10d, in a common subscriber connect/disconnect apparatus.

FIG. 13a is a functional block diagram illustrating one exemplary embodiment of FTTN network architecture useful with various embodiments of the present invention.

FIG. 13b is a functional block diagram illustrating one exemplary embodiment of an intelligent splitter switching apparatus useful with the network architecture of FIG. 13a.

FIG. 14a is a logical flow diagram illustrating one embodiment of the method for processing subscriber connect/disconnect request for use with a single band optical fiber network.

FIG. 14b is a logical flow diagram illustrating one embodiment of the method for processing subscriber connect/disconnect request for use with a dual band optical fiber network configuration.

### DETAILED DESCRIPTION OF THE INVENTION

Reference is now made to the drawings, wherein like numerals refer to like parts throughout.

As used herein, the term “backhaul” refers without limitation to the intermediate links between the core, or backbone, of the network and the small subnetworks at the “edge” of the telecommunications network.

As used herein, the terms “client device” and “end user device” include, but are not limited to, set-top boxes (e.g., DSTBs), personal computers (PCs), and minicomputers, whether desktop, laptop, or otherwise, and mobile devices such as handheld computers, PDAs, personal media devices (PMDs), and smartphones.

As used herein, the terms “CO” or “central office” refer without limitation to a cable, fiber to the home (FTTH), fiber to the curb (FTTC), satellite, or terrestrial network provider's communications facilities having infrastructure required to deliver content into backhaul fiber optic cable connection.

Similarly, the terms “Consumer Premises Equipment (CPE)” and “host device” refer without limitation to any type of electronic equipment located within a consumer's or user's premises and connected to a network. The term “host device” refers generally to a terminal device that has access to digital television content via a satellite, cable, or terrestrial network. The host device functionality may be integrated into a digital television (DTV) set. The term “consumer premises equipment” (CPE) includes such electronic equipment such as set-top boxes, televisions, Digital Video Recorders (DVR), gateway storage devices (Furnace), and ITV Personal Computers.

As used herein, the term “DOCSIS” refers without limitation to any of the existing or planned variants of the Data Over Cable Services Interface Specification, including for example DOCSIS versions 1.0, 1.1, 2.0 and 3.0. DOCSIS (version 1.0) is a standard and protocol for internet access using a “digital” cable network. DOCSIS 1.1 is interoperable with DOCSIS 1.0, and has data rate and latency guarantees (VoIP), as well as improved security compared to DOCSIS 1.0. DOCSIS 2.0 is interoperable with 1.0 and 1.1, yet provides a wider upstream band (6.4 MHz), as well as new modulation formats including TDMA and CDMA. It also provides symmetric services (30 Mbps upstream).

As used herein, the terms “fiber to the premises” or “FTTP” include, but are not limited to, a type of fiber optic communication delivery in which a optical fiber connection is directly run to the customers' premises. These premises can be business, commercial, institutional and other applications where fiber network connections are distributed to a campus, set of structures, or high density building with a centrally located network operations center. Other variants of FTTP are typically categorized into FTTH (fiber to the home), FTTB (fiber to the building), FFTC (fiber to the curb), FFTN (fiber to the node), or FFTx (fiber to a generic node).

As used herein, the term “headend” refers generally and without limitation to a networked system controlled by an operator (e.g., an MSO or multiple systems operator) that distributes programming to MSO clientele having user or client devices. Such programming may include literally any information source/receiver including, inter alia, free-to-air TV channels, pay TV channels, interactive TV, IP TV, and the Internet.

As used herein, the terms “Internet” and “interne” are used interchangeably to refer to inter-networks including, without limitation, the Internet.

As used herein, the term “integrated circuit (IC)” refers to any type of device having any level of integration (including without limitation ULSI, VLSI, and LSI) and irrespective of process or base materials (including, without limitation Si, SiGe, CMOS and GaAs). ICs may include, for example, memory devices (e.g., DRAM, SRAM, DDRAM, EEPROM/Flash, ROM), digital processors, SoC devices, FPGAs, ASICs, ADCs, DACs, transceivers, memory controllers, and other devices, as well as any combinations thereof.

As used herein, the term “mandrel” refers without limitation to a tool or component that can be used to hold fiber windings.

As used herein, the terms “optical network terminal”, “ONT” and “optical network units (ONU) refer without limitation to a powered networking device typically placed at or proximate to subscriber premises, and nodes and used to terminate the fiber optic line, demultiplex and convert the incoming optical signals into traditional electrical signals.

As used herein, the terms “network” “optical network”, “fiber optic network”, and “bearer network” refer generally and without limitation to any type of telecommunications or data network including, without limitation, hybrid fiber coax (HFC) networks, telco networks, and data networks (including MANs, WANs, LANs, WLANs, internets, and intranets). Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., SONET, DOCSIS, IEEE Std. 802.3, ATM, X.25, Frame Relay, 3GPP, 3GPP2, WAP, SIP, UDP, FTP, RTP/RTCP, H.323, etc.).

As used herein, the term “network switch” refers without limitation to a mechanical, electronic, or electromechanical optical device that that connects network segments.

As used herein, the terms “optical line terminal” and “OLT” refer without limitation to a networking device typically placed at the network core (central office or at the head end) location and is used to either generate downstream optical signals on its own, or pass optical signals from the optical backbone through a collocated optical crossconnect or multiplexer. The OLT also receives upstream signals from the optical network terminals (ONTs) at the customer premises and optical network units (ONUs) in remote nodes.

As used herein, the terms “passive optical network” and “PON” refer without limitation to a point-to-multipoint, fiber to the premises network architecture wherein unpowered optical splitters are used to enable a single backhaul fiber connection to serve multiple premises. Such network may further comprise a variety implementations including, inter alfa, Broadband PON (BPON), asynchronous PON (APON), Gigabit PON (GPON, 10G_EPON) and Ethernet PON (EPON), evolutions and variations of thereof.

As used herein, the terms “splitter” or “optical splitter refer without limitation to a mechanical, electronic, or electromechanical optical apparatus that is used to split and combine optical signals from a single backhaul fiber connection into multiple (typically from 2 to 128) end user connections.

As used herein, the terms “MSO” or “multiple systems operator” refer without limitation to a cable, fiber to the home (FTTH), fiber to the curb (FTTC), satellite, or terrestrial network provider having infrastructure required to deliver services including programming and data over those media.

As used herein, the terms “multi-mode optical fiber”, “multimode fiber” or “MM fiber” refer without limitation to a type of optical fiber comprising a larger core-size compared to the single-mode fiber, and supports more than one propagation mode.

As used herein, the terms “network entity”, “network device”, or optical network device” refer without limitation to any network entity (whether software, firmware, and/or hardware based) adapted to perform one or more specific purposes. For example, a network entity may comprise a computer program running in server belonging to a network operator, which is in communication with one or more processes on a CPE or other device.

As used herein, the term “network interface” refers without limitation to any signal, data, or software interface with a component, network or process including, without limitation, those of the Firewire (e.g., FW400, FW800, etc.), USB (e.g., USB2), Ethernet (e.g., 10/100, 10/100/1000 (Gigabit Ethernet), 10-Gig-E, etc.), MoCA, Coaxsys (e.g., TVnet™), radio frequency tuner (e.g., in-band or out-of band, cable modem, etc.), WiFi (802.11a,b,g,n), WiMAX (802.16), PAN (802.15), FibreChannel, FibreChannel over Ethernet (FCOE), internet Small Computer System Interface (iSCSI), Serial Attached SCSI (SAS), Solid-State Drive (SSD), thin film filter opto-electric converter or IrDA families, whether wireless, wireline, or optical in nature.

As used herein, the term “node” refers without limitation to any location, functional entity, or component within a network.

As used herein, the term “QAM” refers without limitation to modulation schemes used for sending signals over cable networks. Such modulation scheme might use any constellation level (e.g. QPSK, QAM-16, QAM-64, QAM-256 etc.) depending on details of a cable network. A QAM may also refer to a physical channel modulated according to the schemes.

As used herein, the term “server” may refer without limitation to any computerized component, system or entity regardless of form which is adapted to provide data, files, applications, content, or other services to one or more other devices or entities on a computer or other network.

As used herein, the term “service”, “content”, “program” and “stream” are sometimes used synonymously to refer to a sequence of packetized data that is provided in what a subscriber may perceive as a service. A “service” (or “content”, or “stream”) in the former, specialized sense may correspond to different types of services in the latter, non-technical sense. For example, a “service” in the specialized sense may correspond to, among others, video broadcast, audio-only broadcast, pay-per-view, or video-on-demand. The perceivable content provided on such a “service” may be live, pre-recorded, delimited in time, un-delimited in time, or of other descriptions. In some cases, a “service” in the specialized sense may correspond to what a subscriber would perceive as a “channel” in traditional broadcast television.

As used herein, the term “switch matrix” refers without limitation to an array of a mechanical, electro-mechanical or electronic switching elements enabling connect and disconnect of individual subscriber premises terminations to the backhaul fiber route.

As used herein, the terms “single mode optic fiber”, “monomode optical fiber”, “single-mode optical waveguide”, or “unimode fiber” refer without limitation to an optical fiber designed to carry only a single ray of light (mode).

As used herein, the term “wireless” means without limitation any wireless signal, data, communication, or other interface including without limitation WiFi, Bluetooth, 3G, HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, analog cellular, CDPD, satellite systems, millimeter wave or microwave systems, acoustic, and infrared (i.e., IrDA).

### Overview

In one salient aspect, the present invention addresses the existing shortcomings related to subscriber disconnect and optical switching discussed above by the purposeful use of signal attenuation due to macrobending losses within the optical fiber. Macrobending is also substantially wavelength dependent, and this dependency may also be advantageously used to deny service via one wavelength, while allowing service using a different wavelength.

A macrobending optical switch apparatus is disclosed, which allows for selective optical device disconnect (and reconnect) within a fiber optic delivery network. In one embodiment, when it is not necessary to completely eliminate or attenuate the optical signal, the macrobending optical switch apparatus is used to merely decrease signal intensity to the point where the value of the service cannot be received, and/or an optical transmitter cannot interfere with desired network operation signal (for instance where a component fails and causes interference with other signals or equipment).

In another embodiment, the macrobending optical switch apparatus is used to selectively induce chromatic dispersion within one or more wavelengths of light being carried on the fiber, thereby providing for range-selective service disconnect or denial due to inter-pulse interference (“smearing”).

In various configurations, the switch apparatus may be (i) manually operated, such as by a service technician at a network hub site, feeder node, or served premises; or (ii) remotely operated at one of the aforementioned locations, such as from a remote (e.g., headend or central office) station in signal communication with the switch apparatus. This latter approach substantially obviates costly “truck rolls”, and allows for reversible service disconnect and reconnect for an almost unlimited number of cycles.

In yet other variants, optical multiplexer apparatus is also utilized (e.g., 1:N multiplexing), and service to selected subscriber premises or network nodes can be disconnected or reconnected remotely.

### DETAILED DESCRIPTION OF EXEMPLARY EMBODIMENTS

Exemplary embodiments of the apparatus and methods of the present invention are now described in detail. While these exemplary embodiments are described in the context of a hybrid fiber coax (HFC) cable architecture having an multiple systems operator (MSO), digital networking capability, and plurality of client devices/CPE, the general principles and advantages of the invention may be extended to other types of networks and architectures, whether broadband, narrowband content or data, or otherwise. Hence, the following description is merely exemplary in nature. For example, the invention may be practiced over a fiber-to-the-premises (FTTP), fiber-to-the-home (FTTH) or fiber-to-the-curb (FTTC) system, or a similar network having two-way capabilities similar to today's digital cable HFC networks (e.g., an HFCu wired network having fiber delivery to distribution nodes).

It will also be appreciated that while described generally in the context of a network providing service to a customer or consumer (i.e., residential) end user domain, the present invention may be readily adapted to other types of environments including, e.g., commercial/enterprise, and government/military applications. Myriad other applications are possible.

It is further noted that while described primarily in the context of 6 MHz RF channels, the present invention is applicable to literally any frequency/bandwidth, such as for example 8 MHz channels. Furthermore, as referenced above, the invention is in no way limited to traditional cable system frequencies (i.e., below 1 GHz), and in fact may be used with systems that operate above 1 GHz band in center frequency or bandwidth, to include without limitation so-called ultra-wideband systems. Additionally, the invention is in no way limited to any particular modulation type or medium access scheme, and can be implemented using for example using QAM, orthogonal frequency division multiplexing (OFDM), sigma-delta modulation (SDM), time-division multiplexing (TDM), etc.

Also, while certain aspects are described primarily in the context of the well-known IP or Internet Protocol (described in, inter alia, RFC 791 and RFC 2460), it will be appreciated that the present invention may utilize other types of protocols (and in fact bearer networks to include other internets and intranets) to implement the described functionality.

It will further be appreciated that while the exemplary embodiments presented herein are described in the context of services that may include multicast and unicast data, the present invention is applicable to other types of services that include multicast transmission of data delivered over a network having multiple physical channels or even virtual or logical channels.

### Bearer Network Architecture—

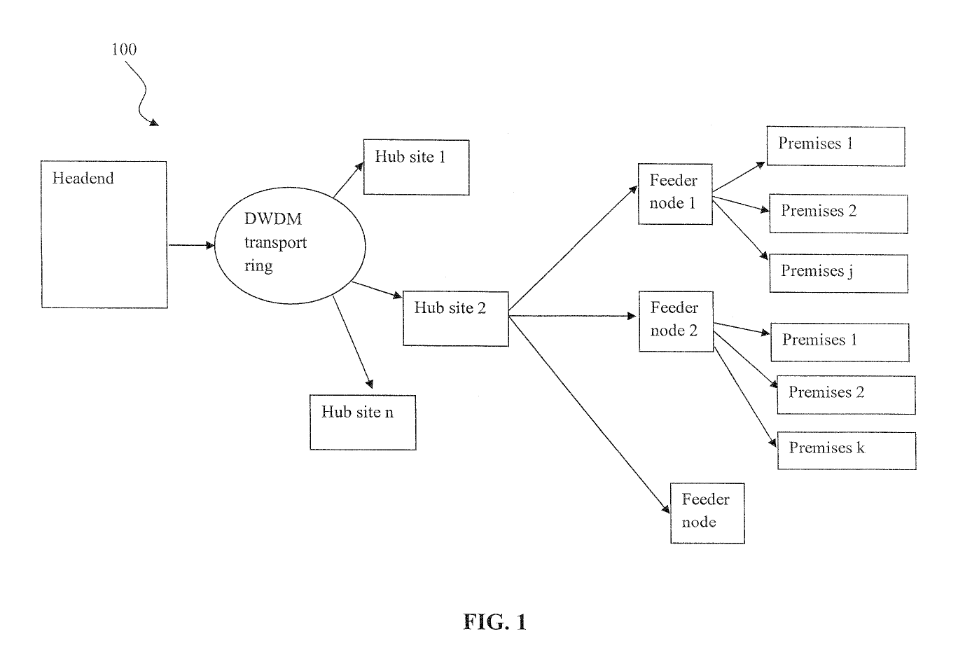

FIG. 1 illustrates one exemplary embodiment of a network architecture for use with one embodiment of the present invention. As shown, the network architecture 100 is generally comprised of a headend, an optical transport ring utilized to distribute the dense wave-division multiplexed (DWDM) optical signals to from the head end to each hub site. The hub sites are used to selectively switch broadcast streams to various feeder nodes that correspond to different service groups. Each feeder node serves a plurality of consumer premises locations. The network shown in FIG. 1 delivers both the “broadcast” content (e.g., video programming as well as the Internet data services using the Internet protocol (IP).

In an embodiment, the transport portion may comprise one or more optical networks (e.g., CWDM, DWDM, Ultra DWDM, etc.) and other portions of the extant cable plant to distribute the multiplexed stream(s) to the various hub sites.

Different components of the network 100 shown in FIG. 1 are interconnected by an optic fiber cable. As described above, different sections of the network need to be disconnected or reconnected in accordance with the current business requirements (such as subscriber number increase or decrease). As described above, cutting, splicing and terminations of optical fiber is costly and time consuming.

In accordance with the principles of the present invention subscriber disconnect and optical switching is achieved by purposeful use of signal attenuation due to macrobending losses within the optical fiber. In one embodiment, macrobending switches are placed directly upstream of consumer premises location, downstream from the feeder node. This allows connect and disconnect of a single subscriber site (such as a house, or a small business location). As a variant, the macrobending switch is placed at the premises location.

In an alternate embodiment, the marcobending switch is placed in-between the feeder node and the hub site. This allows controlling connection state of multiple subscriber premises locations (e.g. a whole vacant office building with multiple individual business locations) with a single switch. As a variant, the switch apparatus is placed at the feeder node.

In a further embodiment, to control connection state for a whole service group, the macrobending switch is placed upstream of the specific hub site. As a variant, the switch is placed at the hub site.

### Exemplary FTTP Network

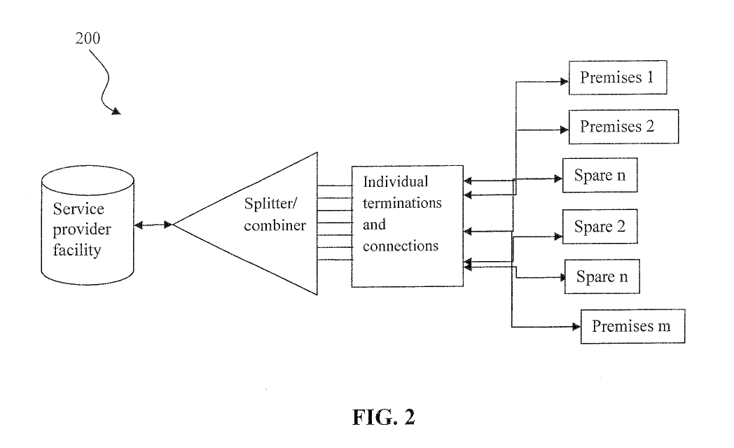

FIG. 2 illustrates a typical Fiber-To-The-Premise (FTTP) fiber optic network (e.g., a Passive Optical “PON” Network) configuration for use with one embodiment of the present invention. FTTP fiber optic networks typically employ a single optical fiber link (backhaul cable) originating at the service provider's facility (e.g. central office, end-office, distribution hub, outdoor enclosure, etc). This single strand of fiber (or single wavelength within the strand in the case of wave division multiplexed systems) connects the service provider facility to a splitter, located at node that is geographically proximate to the customer premises location. The splitter/combiner unit provides the wavelength and fiber multiplexing and demultiplexing and interfaces to at most 32 residential fibers/wavelengths and multiplexes them to the single fiber running from the service provider facility (central office).

Individual terminations and connections are performed downstream from the splitter/combiner to provides connectivity to multiple subscriber premises (residences or businesses). Unused connections are terminated and remain as a spare pool. Optical signals to and from this group of subscribers share the optical connection to the service provider. This topology is commonly referred to as “tree-and-branch.” A tree-and-branch topology is favored for this application because it conserves expensive fiber resources for the backhaul fiber (i.e., service provider facility to the switch node) portion of the network through the sharing of the fiber strand such as via a TDM approach, or sharing of wavelength(s) within the strand. It is distinct from the “star” topology, which requires either a dedicated fiber strand all the way from the facility to the customer, or a dedicated wavelength within that strand.

Although the tree-and-branch topology is favored in the majority of today's FTTP deployments, an important disadvantage is that it is not possible to physically disconnect service to an individual subscriber at the facility end of the connection. This is because the splitter is located near the customer in order to minimize the need for expensive high-count fiber cables enroute. Some type of access control is necessary to prevent service theft. When physical disconnection is used as the access control method, it has the additional advantage of preventing unauthorized and/or malicious injection of signals into the network.

The wavelength window of PON is typically in the 1.5 μm (1500 nm) region for downstream, and 1.3 μm (1300 nm) region for upstream, to support a single fiber system.

In one embodiment, downstream traffic is transmitted from the central office towards the optic splitter/combiner where light signal is passively split and distributed to a plurality of downstream network nodes, such as optical network terminal (ONT) at user premises. Each optic link provides data, voice, and video services to the end subscriber(s) electronically. In the upstream direction, the respective signals from the ONTs are passively combined by the optical combiner. The combined optical signal is then distributed to the central office through a single optical fiber. Some proposed PON schemes utilize wavelengths other than 1.5 μm/1.3 μm or multiplex additional wavelengths to support an analog/digital video overlay on the same fiber. Others use a second PON (video PON) to provide video services. The video PON is typically provided on a parallel fiber that has the same physical layout as the first PON.

### Switch Apparatus—

Embodiments of the present invention addresses the existing shortcomings related to subscriber disconnect and optical switching discussed above by the purposeful use of signal attenuation caused to macrobending losses within the optic fiber.

Macrobending loss (not to be confused with microbending loss) occurs whenever a bend in the optical waveguide causes a light wave within the fiber to exceed the critical angle needed to maintain total internal reflection and enters the cladding material. This loss is very predictable in a given fiber type, although it may be characterized by a “not to exceed” radius (typically 1.5 inches for bare single mode fiber) instead of an actual loss number. In most fiber types typically used in telecommunication (for example, Corning SM-28), radii needed to induce significant macrobending loss (in the range between 30 and 60 mm) are achieved prior to the point at which damage to the fiber occurs. This characteristic is used to advantage in products available in the marketplace, such as to construct optical attenuators with very predictable loss characteristics.

To facilitate implementation of macrobending switching, the optic fiber can be purposefully designed with greater or lesser amounts of macrobending loss. For instance, fiber used for high density installations (e.g., office buildings and high rise apartments) can benefit from reduced macrobending loss radii to allow ease of installation, as the fiber with a lower macrobending loss can be subjected to higher bending (e.g., have multiple loops of spare fiber near termination points) while still maintaining signal quality, when compared to a regular fiber. At the other extreme, the fiber can be designed for increased macrobending losses, so that the required amount of signal attenuation is achieved with a smaller amount of bending, e.g. fewer number of turns around a bobbin.

In one embodiment of the invention, optical switching apparatus (also used for service disconnect) includes a mandrel, or series of mandrels. A physical service disconnect is performed by “winding” the target fiber strand around the mandrels to induce a controlled amount of macrobending loss. It is generally not necessary to completely eliminate the optical signal; rather merely to attenuate it below an optical receiver detection threshold level.

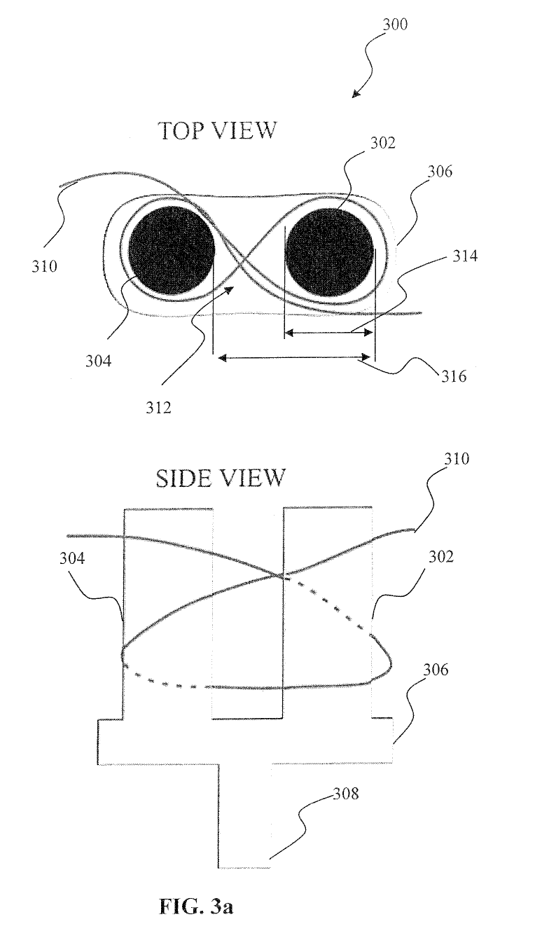

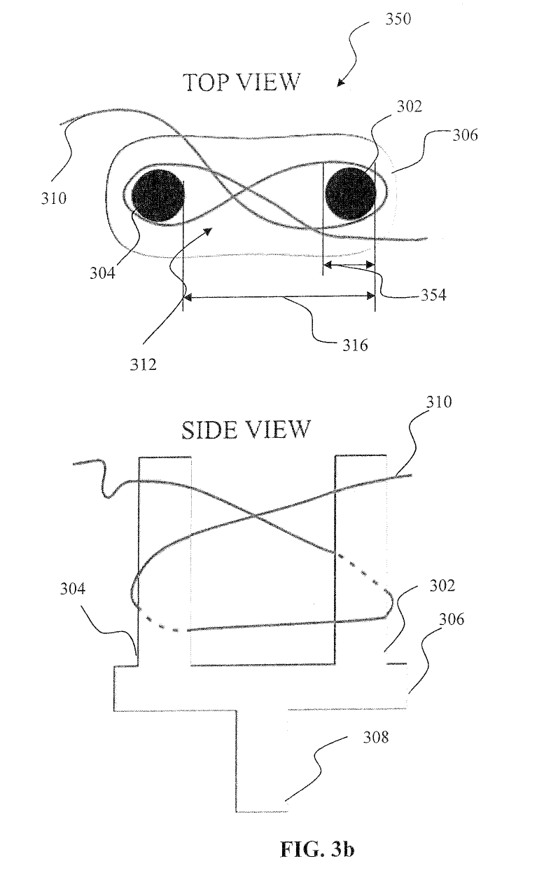

Referring now to FIG. 3a and FIG. 3b, a first embodiment of the optical switching apparatus for use in for service disconnect according to the present invention is described in detail. The switching apparatus 300 comprises two mandrels 302, 304 mounted on a base 306 and optionally, a handle 308. Optic fiber 310 is wound around the mandrels in a “figure-eight” pattern 312. The figure-eight winging configuration is advantageous because it does not impose cumulative twisting of the fiber, and is therefore potentially less stressful to the fiber, more stable, and easier to wrap. However, it will be appreciated that other wrap or winding patterns may be used consistent with the invention.

Switching the optical signal carried within the fiber “off” is performed by winding the target fiber strand 310 around the pair of mandrels 302, 304 to induce a controlled amount of signal attenuation due to macrobending. The amount of signal loss needed to deny service falls into a range that is easily calculated for any optical network by those skilled in the art. The embodiment of FIG. 3a controls the amount of macrobending (and hence the signal loss) by varying the mandrel diameter 314, mandrel spacing 316 and the number of turns in the winding pattern 312.

A macrobending switch embodiment 350, shown in FIG. 3b, uses smaller mandrel diameter 314, as compared to the switching apparatus 300. The embodiment of FIG. 3b produces smaller fiber bending radii and therefore larger attenuation loss. A larger mandrel diameter produces larger bending radii, as shown in FIG. 3a, and therefore less macrobending induced signal loss. While a single winding is shown in FIG. 3a and FIG. 3b for clarity, a plurality of winding “turns” are used to achieve a prescribed value of signal attenuation in one variant.

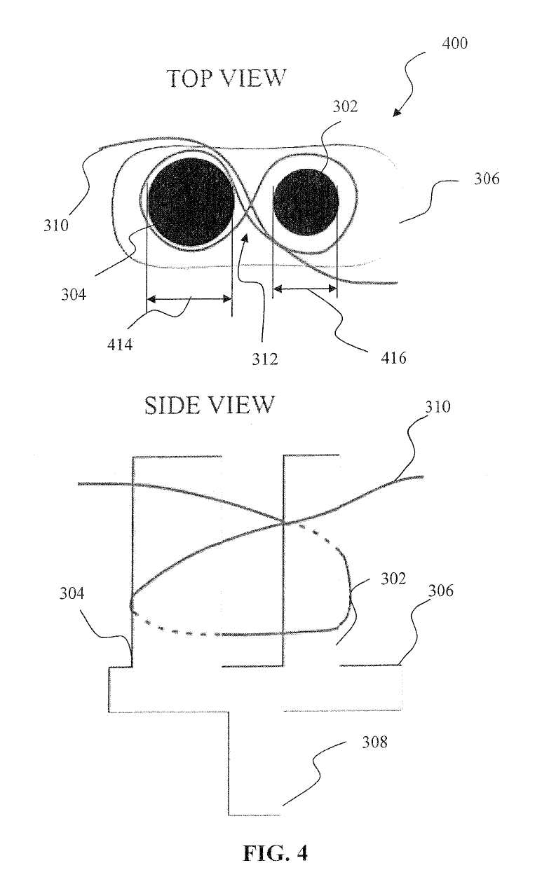

It is also appreciated by those skilled in the art that, the switching apparatus 300, 350 can comprise mandrels of different diameter 414, 416, as depicted in a switch configuration 400 of FIG. 4. Such “different” diameter may include for example: (i) one or more of the mandrels having sections which have different radii; (ii) one or more of the mandrels being linearly or non-linearly tapered so as to have several different radii; (iii) the two or mandrels each having a uniform yet different radius; or (iv) combinations of the foregoing.

Furthermore, mandrel the spacing 316 between mandrels 302, 304 is selected according to the specific design requirements in order to precisely control amount of fiber bending. Closer spacing of the mandrels increases the bending extent of the fiber (by covering a larger portion of mandrel circumference, as illustrated in FIG. 4), therefore increasing macrobending signal loss.

While a single winding is shown in FIG. 4 for clarity, a plurality of windings can be used to achieve a prescribed value of signal attenuation. This underscores another aspect of the present invention; i.e., that several factors including vertical-plane bending; horizontal-plane bending, mandrel diameter, mandrel spacing, and/or number of turns, can be used to achieve a selected level of attenuation.

It is also noted that while the exemplary embodiments of FIG. 3a, FIG. 3b, and FIG. 4 describe manual winding of the optical fiber(s), alternatively such winding can be accomplished by automated means. For example, in an embodiment, the switching apparatus 300 of FIG. 3a can be rotate around an axis that is substantially parallel to the axes of the mandrels. The handle 308 can for instance be mounted on a rotating spool, operatively coupled to a drive mechanism (not shown). To engage the switch the spool is rotated, thus turning the whole switch assembly around the axis, thereby producing additional bends in the optical fiber that result in additional signal loss. As can be appreciated by these skilled in the art, the axis of rotation can be placed anywhere on the base of the switch, and does not need to coincide with its center of symmetry.

In another such embodiment, the apparatus 300 may be held stationary, and the optical fiber fed from a moving dispensing/winding head. Myriad other approaches will be recognized by those of ordinary skill in the mechanical arts given the present disclosure.

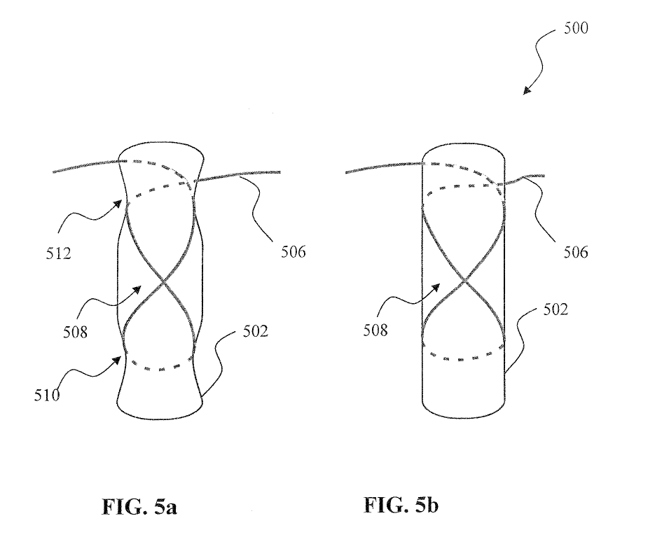

Referring now to FIG. 5a and FIG. 5b, another variant of the optical switching apparatus is described in detail. The apparatus 500 of the illustrated embodiment comprises a generally cylindrical mandrel 502 and optic fiber 506 wound around the mandrel in a “figure-eight” pattern 508. FIG. 5a utilizes a mandrel wherein the diameter of the mandrel is reduced in two areas to form depressions 510, 512. This construction assists in keeping the fiber coiled up on the mandrel, and prevents accidental slipping of the windings. The figure-eight winding configuration is advantageous because it does not result in a cumulative twisting of the fiber, and is, as previously noted, potentially less stressful to the fiber, more stable, and easier to wrap. A switch “off” is performed by winding the target fiber strand 506 around the mandrel 502 to induce a controlled amount of signal attenuation due to macrobending. The amount of loss needed to deny service falls into a range that is readily calculated for any optical network. It is typically not necessary to completely eliminate the optical signal; rather, merely decreasing its intensity to a level not detectable by the receiver is sufficient. As a result, the value of the service cannot be received, and/or an unauthorized optical transmitter cannot interfere with desired network operation.

While a single winding is shown in FIG. 5a and FIG. 5b for clarity, a plurality of windings can be used to achieve a prescribed value of signal attenuation as previously described.

Unlike the mandrel of FIG. 5a, the mandrel 512 shown in FIG. 5b is constructed to have a uniform diameter throughout its length. However, as a variation the mandrel can be constructed to further comprise a plurality of groove-like features; e.g., tracks within which the fiber(s) may reside (not shown).

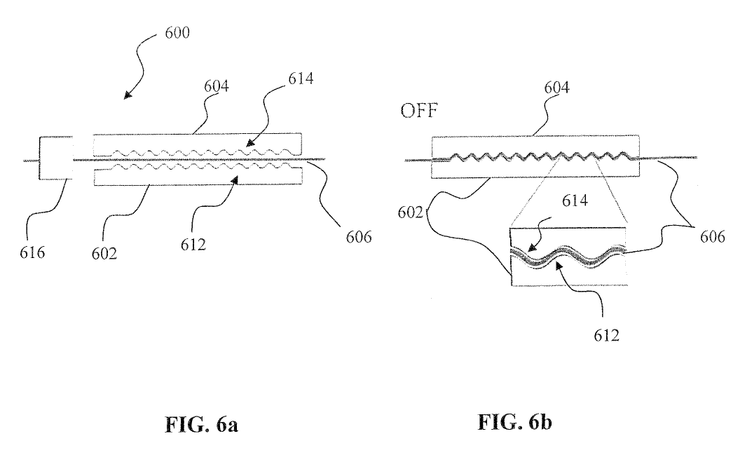

Referring now to FIG. 6a, another exemplary embodiment of the optical switching apparatus is described in detail. The apparatus 600 of FIG. 6a comprises a pair of mandrels 602, 604 that are facing each other along a central dimension. A fiber strand 606 is routed in between the mandrels, and a tension mechanism 610 disposed at one end of the mandrel switching apparatus 600.

Each mandrel 602, 604 further comprises a periodic or wave like pattern 612, 614 disposed on the inner surface (facing the other mandrel) as shown in FIG. 6a. The mandrels 602, 604 are affixed to a base, enclosure, mounting plate, or other structure (not shown). The apparatus 600 may further comprise a guide that restricts motion of the fiber strand in the plane that is orthogonal to the plane of the undulations, and a mechanism for moving the mandrels in the longitudinal dimension if desired. A tension apparatus 616 may be further employed to ‘pick up slack fiber (particularly in the on position) and prevent coiling and damage of the fiber cable.

The shape of individual undulations 612, 614 is chosen such that (i) to avoid creation of sharp edges what would damage the fiber strand, and (ii) to achieve a bending radius that causes macrobending attenuation.

In the “ON” position depicted in FIG. 6a, the mandrels 602, 604 are spaced sufficiently apart to ensure that fiber strand 606 is routed through the mandrel pair without incurring any significant bends. To actuate switch into the “OFF” position mandrels 602, 604 are moved towards each other longitudinally so that the fiber strand is pressed in-between the undulated sides 612, 614, therefore imposing a plurality of bends. A magnified section of bended strand is shown in the insert in FIG. 6b. As with the other embodiments, the amount of loss needed to deny service falls into a range that is easily calculated or experimentally determined for any optical network by those skilled in the art. It is typically not necessary to completely eliminate the optical signal; merely to decrease its intensity to a level not detectable by the receiver. As a result, it will be appreciated by those skilled in the art that switching apparatus 600 can comprise fewer or more bends that is shown in FIGS. 6a and 6b, and/or different shapes and severity of bends, so as to achieve the desired properties. Moreover, engagement of the two mandrels can be controlled in various manners so as to adjust the level of attenuation. For example, in one variant, both mandrel pieces are linear (planar, but for the surface undulations), and their spacing from one another controlled so as to induce more or less bending of the fiber. In another variant, one or more of the surfaces are non-planar (e.g., curved in a non-constant fashion in their long dimension) so as to allow for more progressive engagement and attenuation. Various other schemes for progressive attenuation will be recognized by those of ordinary skill given the present disclosure.

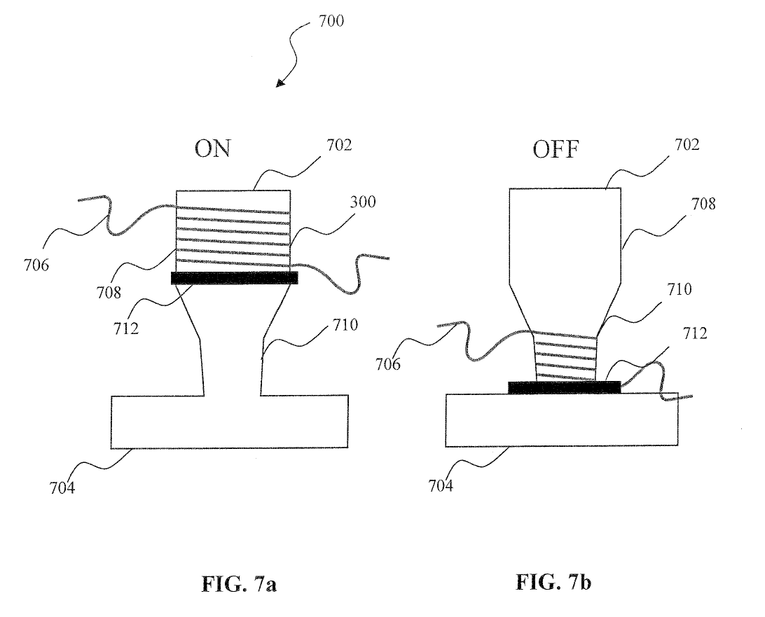

Referring now to FIG. 7a, another exemplary embodiment of the optical switching apparatus is described in detail. The apparatus 700 of the illustrated embodiment comprises a mandrel 702, a base 704, and optical fiber 706 wound around the mandrel that further comprises two sections: top cylindrical portion 708, and bottom tapered portion 710. Tapered portion 710 is constructed to have the same diameter as the cylindrical portion on the top side, and a reduced diameter on the opposite side proximate to base 704. A raised ring or retainer 712 is also optionally provided, so as to limit the optical fiber on the top portion from sliding downward onto the lower portion due to the force of gravity. The smallest diameter of the tapered portion is chosen such, that macrobending occurs when optic fiber 706 is wound around this portion of the mandrel.

FIG. 7a depicts the switching apparatus 700 in the “ON” position, wherein the fiber is wound around top portion 708 of the mandrel. In FIG. 7b, the switch 700 is placed into the “OFF” position by rewinding or sliding the fiber spool down to tapered portion 710 of the mandrel 702. Slack in the fiber spool in the latter case can removed by a tension device (not shown). The fiber bend radius is reduced, therefore producing macrobending-induced attenuation.

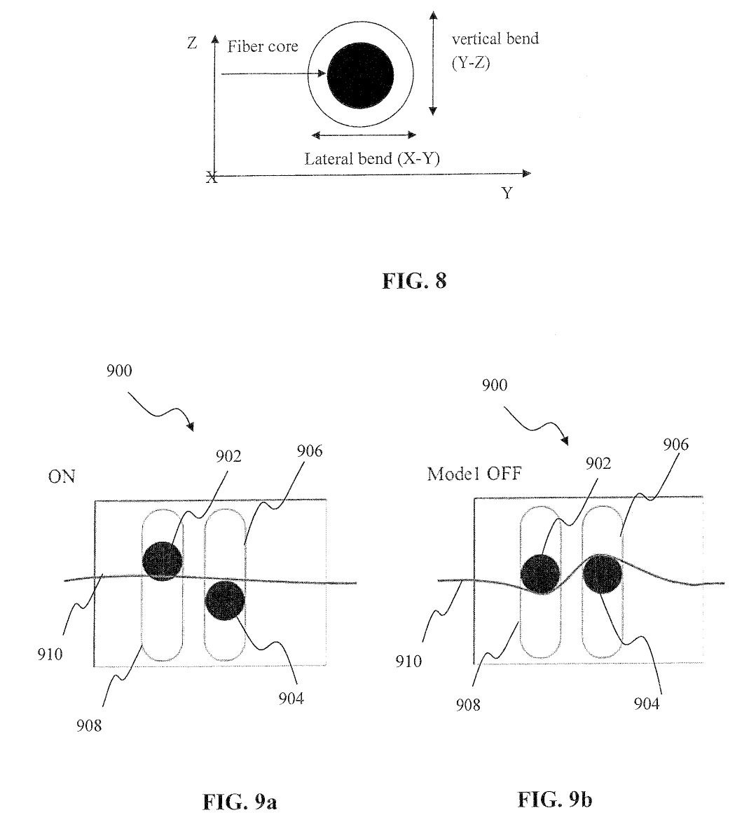

FIG. 8 illustrates one exemplary coordinate system used to describe fiber bending. The optical fiber cross section is shown, with X-axis (abscissa) pointing along the fiber length (into the plane of the page). Lateral bending refers to fiber bend around the Z-axis direction in the X-Y plane, while vertical bend refers to bending around Y-axis (ordinate) direction in the Y-Z plane. It will be appreciated however that this reference system is purely arbitrary, and merely but one possible way of describing the distortion of the fiber.

### Alternate Embodiments of Switching Apparatus

The optical switching apparatus described above with respect to FIGS. 3 through 7 generally require manual winding of the optical fiber in order to perform the desired switching operation(s). To expand the usefulness of these macrobending switching devices, mechanized switches that enable partially or even fully automated operation are now described.

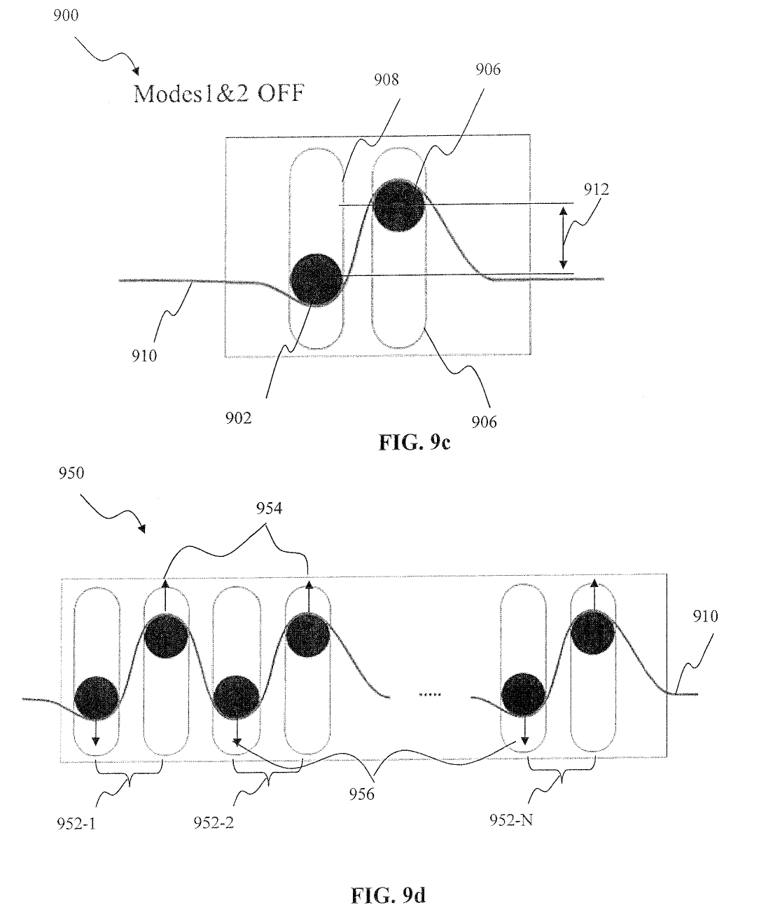

Referring now to FIG. 9a, the switching apparatus 900 of the illustrated embodiment comprises a pair of motorized rollers 902, 904, each housed in a separate respective guide slot 906, 908. The optical fiber 910 is arranged to pass between the rollers, as in the configuration shown in FIG. 9a. The rollers 902, 904 are operatively coupled to a linear mechanized drive apparatus (not shown). Such apparatus are well known in the arts, and are not described in further detail herein.

FIG. 9a shows the switching apparatus 900 in the “ON” position, wherein the rollers 902, 904 are positioned at either side of fiber strand 910 such that they do not to cause macrobending in the fiber. To place switch apparatus 900 into the “OFF” state, the rollers 902, 904 are moved in the opposite directions towards the fiber axis (or more simply one roller moved relative to the other to effect the same relative change). In the exemplary embodiment illustrated in FIG. 9a and FIG. 9b, the first roller 902 is moved down, and the second roller 904 is moved up in the figure plane, thereby creating two bends in the fiber 910. The fiber material, roller size, position and travel length are selected so as to produce the level of macrobending required to achieve the desired signal loss.

Macrobending is wavelength dependent, and this dependency may potentially be used in certain embodiment of the invention to deny service using one wavelength, while allowing service using a different wavelength, hereinafter also referred to as bands. Different amounts of roller travel produce different amounts of bending, hence enabling selective wavelength or selective band switching. FIG. 9b illustrates switching of Mode 1 of the optical fiber (corresponding to a given wavelength), while FIG. 9c illustrates switching of both Band 1 and Band 2 by moving the rollers 902, 904 further (thus resulting a larger roller to roller distance 912) in their direction of travel as compared to FIG. 9b.

As with prior embodiments, it is typically not necessary to completely eliminate the optical signal; merely to decrease its intensity to a level not detectable by the receiver. When an additional attenuation is required, the exemplary switching apparatus described in FIG. 9a can be modified to comprise additional rollers as illustrated for example in FIG. 9d. The apparatus 950 comprises multiple sets op roller pairs 952-1, 952-2, 952-N, wherein each alternating (e.g., evenly numbered) roller is configured to move in opposite directions with respect to the neighboring (e.g., odd numbered) roller in the manner similar to that described above with respect to FIGS. 9a and 9b. Each additional pair of rollers 952 inflicts additional macrobending radius in the fiber, and therefore increases the overall signal loss that is produced by the modified switching apparatus 950.

In another variant, each individual roller can be independently controlled by a separate drive apparatus.

As another alternative, all alternate rollers (i.e., all evenly numbered and all odd numbered rollers) can be coupled to a single common rail (i.e., one rail for the even-numbered and another rail for the odd-numbered roller respectively). This configuration enables moving all of the rollers within the set (e.g., all evenly-numbered rollers) simultaneously in the same manner. While such a configuration does not offer as much flexibility compared to the aforementioned individually controlled roller configuration, it is much simpler to construct, as it requires only two driving mechanisms. In addition, the number of rollers in switching apparatus 900 can be increased or decreased without requiring additional driving apparatus.

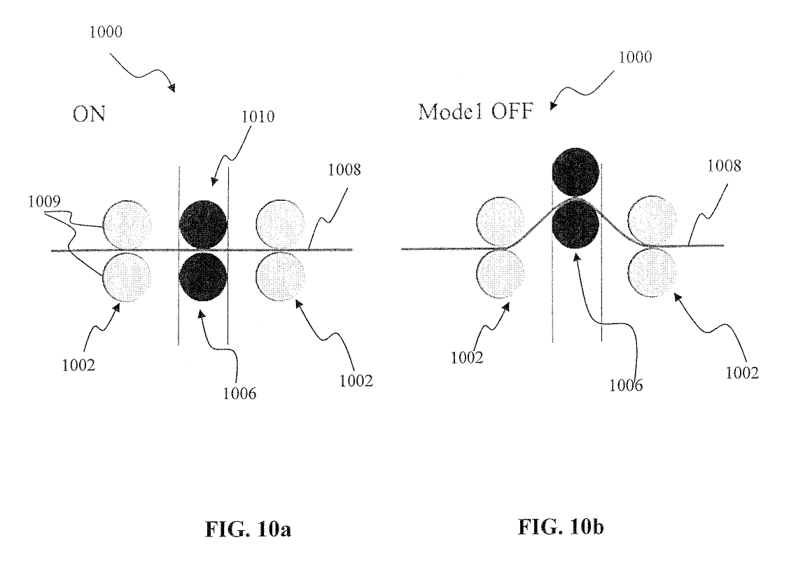

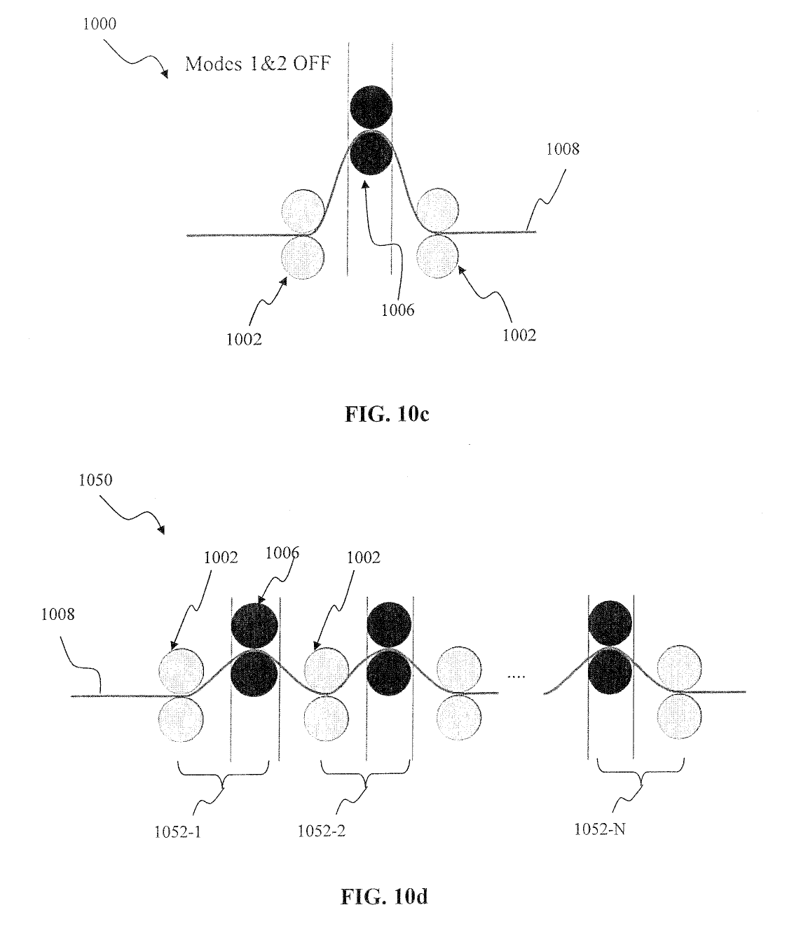

Referring now to FIG. 10a, another variant of exemplary embodiment of the mechanized optical switching apparatus of the invention is described in detail. The switching apparatus 1000 of this embodiment comprises two pairs of fixed pin-pairs 1002 placed on both sides of a movable pin-pair 1006. The optical fiber 1008 routed between individual pins (e.g. 1009) within each pair, as shown in FIG. 10. The movable pin-pair 1006 is further located within the guide slot 1010, and is operatively coupled to a drive apparatus (not shown). Such drive apparatus (both mechanized and manual) are well known in the art, and accordingly are not described in further detail herein.

FIG. 10a depicts the switch 1000 in the “ON” state, wherein the movable pin-pair 1006 is aligned with the fixed pin-pairs 1002 to form a ‘neutral’ position such that the fiber 1010 is not bent. To engage the switch apparatus 1000 into the “OFF” state, the movable pin-pair 1006 is moved away from the neutral position. In the exemplary embodiment illustrated in FIG. 10b and FIG. 10c, the pin-pair 1006 is moved upwards. This displacement creates three bends in the fiber 1010, thereby producing macrobending signal loss.

Different amounts of pin-pair 1006 travel produce different amounts of bending, hence enable selective optical band (wavelength) switching.

FIG. 10b illustrates switching-off of a first band (Band 1), while FIG. 10c illustrates switching-off of both first and second bands (Band 1 and 2) achieved by moving the pin-pair 1006 further away from the neutral position, as compared to the apparatus of FIG. 10b.

As yet another example, to increase the amount of attenuation or loss, the switching apparatus 1050 shown in FIG. 10d comprises a plurality of pin-pairs 1002, 1006 arranged in an alternating sequence. As shown, each fixed pin-pair is followed in sequence by a movable pin-pair, and then another fixed pin-pair, and so on, thus creating multiple sets of pin pairs 1052-1, 1052-2, . . . 1052-N. When the movable pin-pair 1004 are displaced from the neutral position, each set 1052 of pin-pairs 1002, 1006 produces additional bending as depicted in FIG. 10d. As a result, the overall signal loss produced by the switching apparatus 1050 of FIG. 10d is greater as compared to the switch apparatus 1000 of the embodiment illustrated in FIG. 10a. In one embodiment, all of the movable pin-pairs are moved in the same manner. In another embodiment, each movable pin pair is controlled independently in order to achieve a more precise control of signal loss.

Yet as another variant, switch 1050 of the embodiment depicted in FIG. 10d comprises a plurality of fixed rollers mounted on a rotating base (not shown).

It is noted that the embodiments described above are for illustration purposes only. Myriad different configurations for practicing the invention will be recognized by those of ordinary skill when provided the present disclosure.

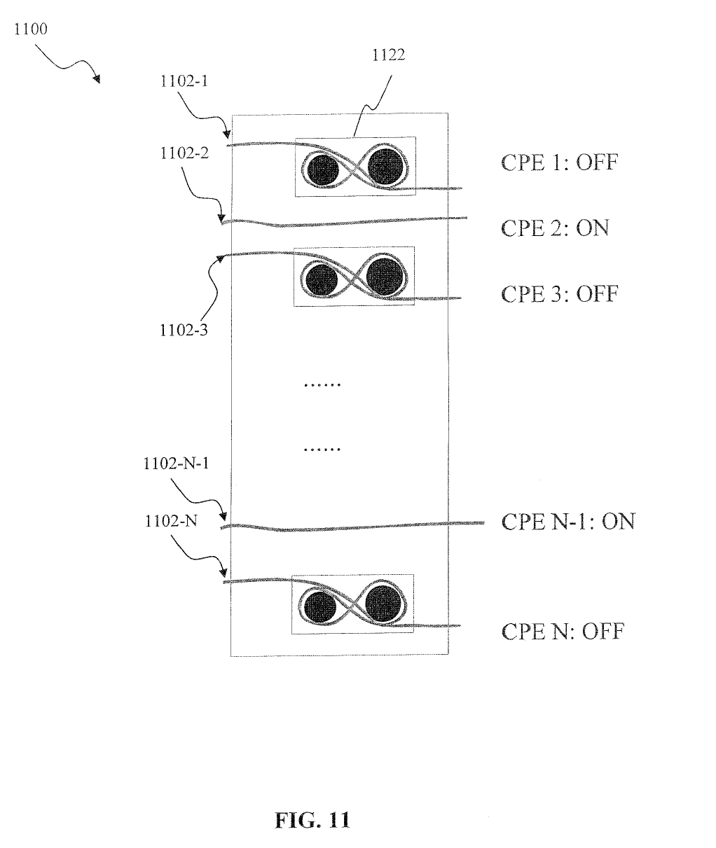

Referring now to FIG. 11, one embodiment of a multichannel optical switch apparatus 1100 for use in service disconnect is described in detail. The multichannel switch apparatus 1100 comprises a plurality of macrobending optical switching apparatus 1122, e.g., of the type detailed above in FIG. 4. Each individual switch 1122 controls a separate subscriber optical fiber channel 1102. In this embodiment, the switches are installed only in the fibers channels 1102-1, 1102-3, 1102-N corresponding to CPE1, CPE3, and CPE N that require disconnect. The remaining fiber channels remain undisturbed. The above channel configuration is shown for illustrative purposes only; it will be apparent to those skilled in the arts that literally any permutation or combination of channels/switches is feasible. Additionally, each of the macrobending channel switches can be coupled to a drive mechanism that enables axial rotation of each switch in the manner described above, if desired.

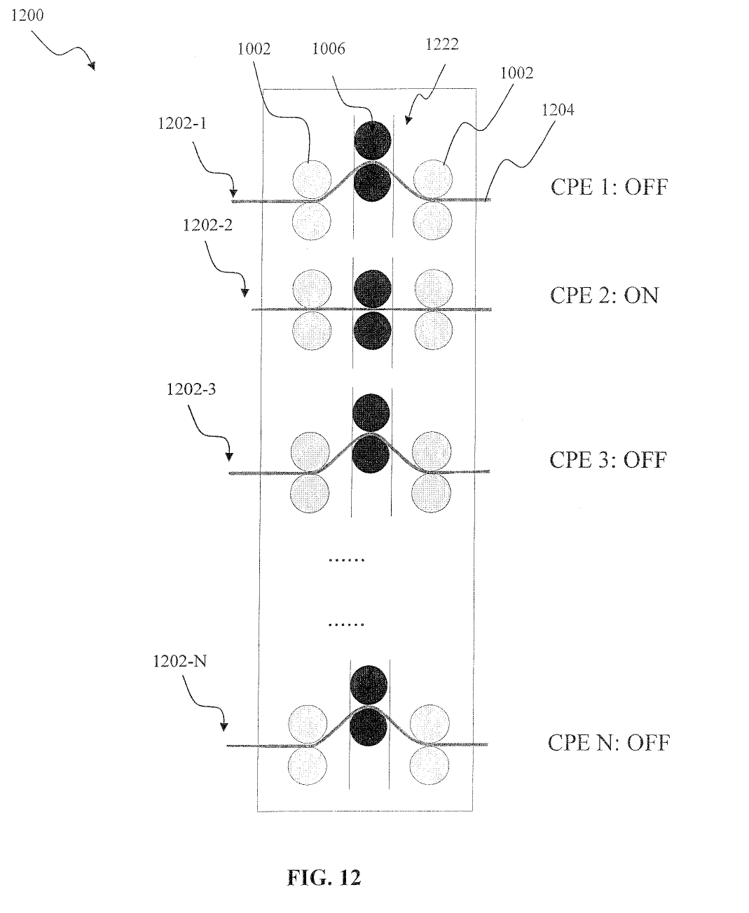

Referring now to FIG. 12, another embodiment of the multichannel optical switching configuration is described in detail. In this embodiment, the multichannel switch apparatus 1200 comprises a plurality of individual macrobending optical switches 1222 of the configuration described above with respect to FIG. 10a, each switch controlling a separate optical fiber. Other implementations are possible, such as for example a single switch base with a plurality of individually controlled channels.

Each switch channel 1222 is in this embodiment individually controlled. The switch as shown in FIG. 12 comprises one movable pin-pair 1006 and two fixed pin pairs 1002: one on either side of the fixed roller. The moveable pin-pair is operably coupled to a mechanized drive apparatus (not shown), and is configured to move in the direction that is substantially perpendicular to the axial dimension of the optical fiber 1204. It will be appreciated by those skilled in the art that the direction of pin-pair 1006 motion does not need to be precisely perpendicular to the axial dimension of the optical fiber, but only sufficiently different (from the fiber axial dimension) so as to induce bends in the fiber. In order to connect or disconnect service for a particular channel 1202 the corresponding switch is placed in the appropriate position by actuating movable pin-pair. In the example, shown in FIG. 12, a CPE on channel 1202-2 is connected, while CPEs on channels 1202-1, 12-2-3, 1202-N are disconnected.

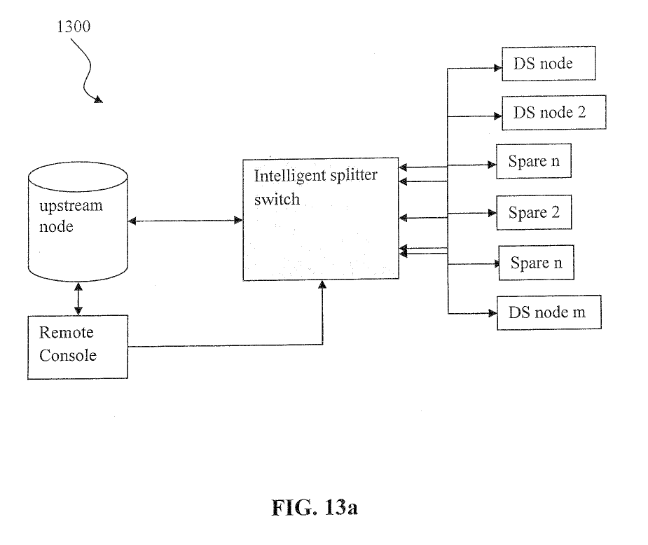

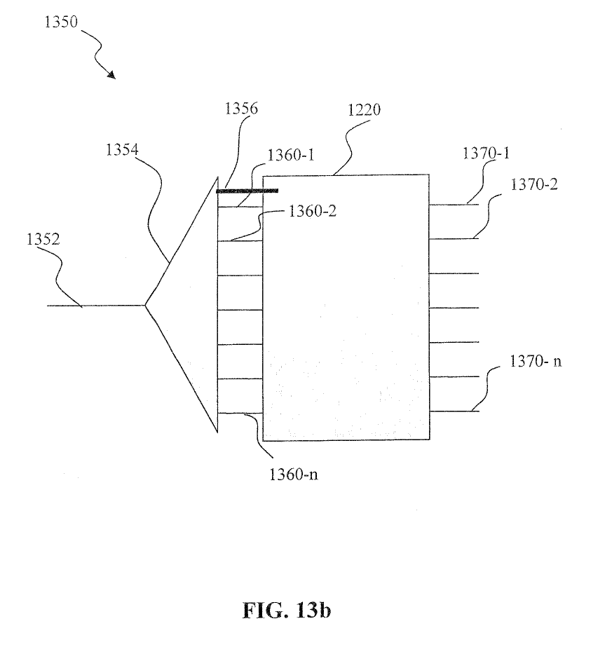

Referring now to FIG. 13a, a functional block diagram of one exemplary optical fiber network 1300 useful with a multichannel switching apparatus of the present invention is described in detail. FIG. 13a shows an intelligent splitter switch connected by a fiber optic link to an upstream node. The upstream node may comprise any suitable service provider facility, such as central office (CO), end office, distribution hub (hub site), feeder node, outdoor enclosure, etc.

The fiber optic link can comprise a full fiber optic cable (such as backhaul cable) or a single wavelength within the strand. The intelligent optical splitter/switching apparatus further communicates with a plurality of downstream (DS) nodes. These DS nodes correspond to a next level (from the upstream node) in the network hierarchy and can comprise a hub site node, a feeder node, or a consumer premises CPE (e.g., subscriber receivers).

Typically a single splitter switch can accommodate from 32 to 128 individual downstream links (CPE), although other configurations are contemplated. The network 1300 further comprises a remote console 1370 for controlling network switching operations. The remote console 1352 can be placed in any practical location (either inside or outside the central office upstream node) that is in data communication with the network 1300.

Referring now to FIG. 13b, the splitter switch apparatus 1350 of FIG. 13a is described in further detail. The switch 1350 comprises a splitter/combiner 1354 that performs wavelength and fiber multiplexing and demultiplexing between the upstream link 1352 and a plurality (n) of downstream links 1360-1 through 1360-n. Typically, a single splitter apparatus 1354 interfaces 32, 128, etc. residential fibers/wavelengths, and multiplexes them to the single fiber running from the central office, although this is by no means a requirement of practicing the invention.

In one embodiment, the switch 1350 further comprises a multichannel optical macrobending switching apparatus 1220 (as an example, one similar to the apparatus 1220 described above with respect to FIG. 12).

In addition to performing multiplexing functionality, the splitter/apparatus 1354 is further configured to receive control instructions from the network via e.g., an incoming fiber link 1352. These control instructions are subsequently routed via a dedicated control link 1356 to the multichannel switch 1220. Optionally, the control link can comprise for example a wired or wireless communications channel (not shown) such as GigE (Gigabit Ethernet), IEEE-Std. 1394, DSL/DOCSIS modem, T1 line, LAN, WiFi, WiMAX, CDMA, GSM/GPRS, or other RF link, or literally any other type of information channel or modality.

In response to the receipt of one or more control instructions, the multichannel switch performs subscriber connect/disconnect by actuating appropriate channel of the multichannel switch 1220 and either connecting or disconnecting the appropriate downstream link 1370-1 through 1370-n.

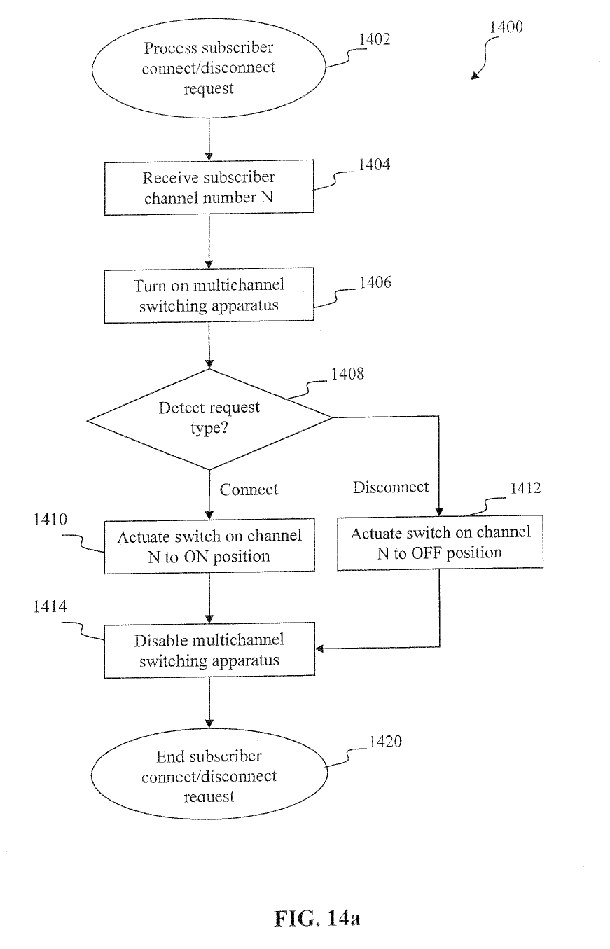

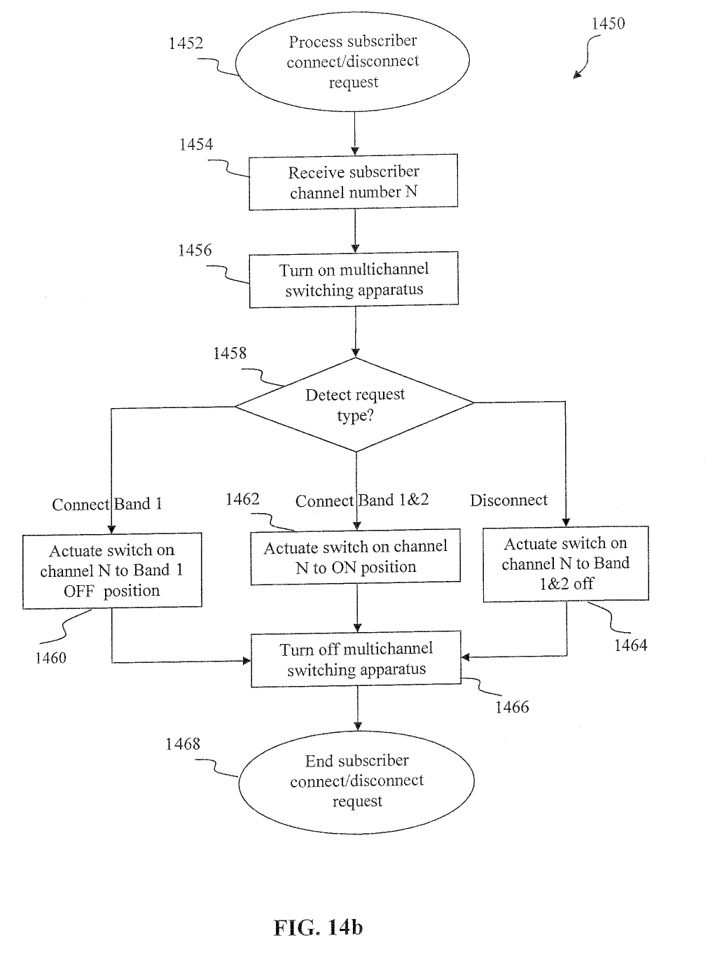

FIG. 14a illustrates one embodiment of the method 1400 for processing a subscriber connect/disconnect request in accordance with the present invention. In one aspect, at step 1404 the incoming subscriber connection status change (connect or disconnect) request 1402 is analyzed to obtain the subscriber channel number N (switch channel that corresponds to the specific subscriber premises physical address) for the change request to be applied to. At step 1406, the multichannel switching apparatus (e.g., the intelligent splitter switch described above with respect to FIG. 13a and FIG. 13b) is turned on. At step 1408 the request type is analyzed to determine if this is a connect or disconnect request. If the request is to connect a new (or reconnect an existing) subscriber (depicted by a ‘Connect’ arrow coming out from block 1408) the N^{th} channel of the multichannel switching apparatus is actuated into the ‘ON’ position at step 1410. If the request is to disconnect an existing subscriber (depicted by a ‘Disconnect’ arrow coming out from block 1408) the N^{th} channel of the multichannel switching apparatus is actuated into the ‘OFF’ position at step 1412. At step 1414 the multichannel switch is turned off thus completing the connection request processing sequence.

FIG. 14b further illustrates one embodiment of the method 1450 for processing a subscriber connect/disconnect request, used in a multimode network configuration, in accordance with the present invention. At step 1454 the incoming subscriber connection status change (connect or disconnect) request 1452 is analyzed to obtain the subscriber channel number N (switch channel that corresponds to the specific subscriber premises physical address) for the change request to be applied to. At step 1456, the multichannel switching apparatus (e.g., the intelligent splitter switch described above with respect to FIG. 13a and FIG. 13b) is turned on. At step 1458 the request type is analyzed to determine if this is a connect or a disconnect request. The difference compared to the embodiment of FIG. 14b that here the request can comprise one of three states: disconnect service, or connect service on band 1 (mode 1), or connect service for both band 1 and band 2 (mode 1 and mode 1).

If the request detected at step 1458 is to connect service for a new (or reconnect an existing) subscriber on band 1 (depicted by a ‘Connect Band 1’ arrow coming out from block 1458) the N^{th} channel of the multichannel switching apparatus is actuated into the ‘Connect Mode 1’ position at step 1460. If the request detected at step 1458 is to connect service for a new (or reconnect an existing) subscriber on bands 1 and 2 (depicted by a ‘Connect Band 1 & 2’ arrow coming out from block 1458) the N^{th} channel of the multichannel switching apparatus is actuated into the ‘Connect Mode 1 & 2’ position at step 1462. If the request is to disconnect an existing subscriber (depicted by a ‘Disconnect’ arrow coming out from block 1458) the N^{th} channel of the multichannel switching apparatus is actuated into the ‘OFF’ position at step 1464. At step 1466 the multichannel switch is turned off thus completing the connection request processing sequence.

While exemplary embodiments described above with respect to FIG. 14a and FIG. 14b illustrate controlling a single subscriber channel per request, it is appreciated by these skilled in the art that a plurality of channels can be simultaneously controlled as a part of a single multichannel request, wherein multiple subscriber channels are switched on or off at e.g., step 1410 or 1412, respectively.

In the exemplary embodiments of FIG. 14a and FIG. 14b, the physical service disconnect is enabled by an installed switch having the fiber routed between the guides, and operatively coupled to the switch control mechanism for remote control. As can be appreciated by these skilled in the art, any mechanized macrobending switch configuration, such as shown above in FIG. 6a, FIG. 7a, and FIG. 9a through FIG. 9d, and others that are contemplated by the present invention, can be used for service disconnect and reconnect with the embodiments of FIG. 14a and FIG. 14b.

However, the process illustrated in FIG. 14a and FIG. 14b can be similarly performed by an operator using manual macrobending switches, such as these illustrated by, inter alia, FIG. 3a, FIG. 3b, FIG. 4, FIG. 5a, FIG. 6a, and FIG. 7a.

As in a connector or splice-based physical disconnect approach, it is often necessary to physically secure the disconnect mechanism in order to prevent unauthorized reconnection. This can be accomplished using commonly available techniques such as locks and tamper resistant enclosures already developed and deployed.

It is also appreciated that the techniques described herein may or may not employ fiber that is specifically designed for control of the macrobending characteristics. For example, certain types and/or configurations of fiber are more or less optimized for macrobending control; this may be for example by virtue of their physical properties (e.g., resistance to bending, tendency to suffer fatigue stress when repeatedly bent and unbent, limitations on their bend radius) and/or optical properties (e.g., relationship of bend radius or angle to the level of signal attenuation, ability to selectively attenuate modes or wavelengths of light, etc.). Accordingly, while one or more of the foregoing macrobending switch apparatus can readily be configured to use extant fiber that is part of the installed fiber base for a given network, the present invention also contemplates retrofitting (or new installation) of “optimized” fiber for use with the switch apparatus.

### Chromatic Dispersion-Based Variants—

The temporal spreading of an optical pulse in an optical fiber (“chromatic dispersion”) is caused by differences in wave velocity in the medium. Chromatic dispersion is often measured in picoseconds of pulse spreading per nanometer of spectral width per kilometer of fiber length. There are generally two sources of dispersion: material dispersion and waveguide dispersion. Chromatic dispersion is typically quantified as the sum of waveguide dispersion and material dispersion. Material dispersion is caused by the fact that the speed of light in a medium is sensitive to the wavelength; i.e., the velocity of light in a medium depends on its wavelength. Waveguide dispersion is caused by the fact that a given wavelength travels at different speeds in the core and cladding of a single-mode fiber (SMF). Material dispersion, waveguide dispersion, and, therefore chromatic dispersion, are issues in long haul fiber optic transmission systems (FOTS) employing single-mode fiber (SMF) of step-index construction. Multimode fiber (MMF) and graded-index fiber suffer so much from modal dispersion over short distances that material dispersion and chromatic dispersion generally never become salient factors. Chromatic dispersion effectively produces pulses spread out in time, such that they begin to run into the front or back end of another pulse, thereby resulting “smearing out” of the signal over distance.

Accordingly, this phenomenon can be used to advantage within other embodiments of the present invention. Specifically, it is known that bending of a single mode fiber introduces additional reflections; these reflections are substantially wavelength dependent, and will be differently affect by chromatic dispersion. In that dispersion effects are distance dependent, some given distance (X) downstream from the macrobending switch will experience degradation to the point where the optic signal becomes unusable for reception by a node as a result of macrobends induced upstream. This feature allows for inter alfa, selective denial of service across a whole network branch disposed at a distance X (or greater) downstream from the macrobending switch without requiring individual control for each of the sub-branches.

Hence, the two types of control (macrobending-induced attenuation of signal strength, and macrob ending-induced chromatic dispersion) can be applied individually or collectively in order to achieve the desired effect downstream. For instance, it may be that a lesser level of macrobending (i.e., less severe bend) is sufficient to “smear” the signal via pulse dispersion at a distance of X or grater, but still allow operation for nodes at a distance less than X. When shutoff of all downstream nodes (at zero to X and beyond) is desired, a more sever bend can be imparted, thereby significantly attenuating the signal.

It will also be appreciated that the inter-pulse guard band or gap can be adjusted to allow selective shutoff at a prescribed bend radius; i.e., bunch the pulses close enough together that even slight bend-induced chromatic dispersion will effect the desired smearing, with minimal stress on the fiber.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. This description is in no way meant to be limiting, but rather should be taken as illustrative of the general principles of the invention. The scope of the invention should be determined with reference to the claims.

What is claimed is:

1. Network switching apparatus configured to selectively vary a bend radius of an optical conduit, said variation attenuating one or more optical transmissions through said conduit to effect switching form a first mode to a second mode.

2. The network switching apparatus of claim 1, wherein said conduit comprises a single-mode optical fiber.

3. The network switching apparatus of claim 2, wherein the second mode comprises attenuating said one or more optical transmissions so as to substantially frustrate said optical transmissions being utilized a downstream network node.

4. The network switching apparatus of claim 2, wherein said second mode comprises inducing chromatic dispersion within the pulses of said one or more optical transmissions so as to substantially frustrate said optical transmissions being utilized a downstream network node.

5. The network switching apparatus of claim 1, wherein said switching apparatus comprises a plurality of rollers configured to move at least a portion of said conduit in a direction substantially perpendicular to a longitudinal dimension of said conduit.

6. The network switching apparatus of claim 5, further comprising a driver apparatus operatively coupled to at least a portion of said plurality of rollers and configured to effect movement of said at least portion of said rollers.

7. The network switching apparatus of apparatus of claim 5, further comprising a plurality of fixed rollers disposed proximate to said plurality of rollers configured to move, said fixed rollers configured to substantially block at least a portion of said conduit.

8. The network switching apparatus of claim 1, wherein said switching apparatus comprises at least two pairs of rollers, said pairs of rollers configured to move in substantially opposite directions from each other along an axis that is substantially perpendicular to a longitudinal dimension of said conduit.

9. The network switching apparatus of claim 1, wherein said switching apparatus comprises a post of a varying diameter, defining at least a first radius and a second radius, and adapted for said conduit to move between the first radius and the second radius.

10. The network switching apparatus of claim 1, wherein said switching apparatus comprises at least two posts configured to receive at least a portion of said conduit such that when said conduit is disposed on said at least two posts, at least a portion of said conduit assumes a radius that substantially attenuates at least a portion of said one or more optical transmissions.

11. The network switching apparatus of claim 6, further comprising a remote controller apparatus operatively coupled to said driver apparatus and configured to receive commands; and
wherein said driver apparatus is further configured to move said plurality of rollers in response to said commands.

12. The network switching apparatus of claim 1, wherein said one or more optical transmissions further comprise a plurality of frequency bands, wherein said switching comprises attenuating so as to selectively frustrate optical transmission to a downstream network node in one or more selected ones of said plurality of frequency bands.

13. Apparatus configured to selectively attenuate optical transmissions through a conduit comprising:
an optical conduit, at least a portion of the conduit routed through said apparatus; and
apparatus configured to selectively vary a bend radius of said optical conduit so as to effect said attenuation.

14. The apparatus of claim 13, wherein conduit comprises a single-mode optical fiber.

15. The apparatus of claim 13, wherein:
said optical conduit comprises a multiple mode optical fiber; and
said selective attenuation substantially attenuates said optical transmissions of at least one mode from multiple modes being carried in said fiber.

16. The apparatus of claim 13, wherein said optical transmissions comprise a plurality of frequency bands, and said selective attenuation selectively attenuates said optical transmissions within one of said plurality of frequency bands.

17. The apparatus of claim 13, wherein said attenuating is configured to substantially frustrate receipt of said optical transmission at a downstream network node.

18. The apparatus of claim 13, wherein said apparatus configured to selectively vary comprises a plurality of rollers configured to move at least a portion of said conduit in a direction substantially perpendicular to a longitudinal dimension of said conduit.

19. The apparatus of claim 18, further comprising a driver apparatus operatively coupled to said plurality of rollers and configured to effect movement of said rollers.

20. An apparatus for use in network having fiber optic transmission, the apparatus comprising:
a first port adapted to receive at least a portion of an incoming optical fiber;
a plurality of output ports;
a first apparatus configured to
selectively couple said incoming optical fiber to at least one of said plurality output ports; and
selectively attenuate optical transmissions delivered through at least one of said plurality output ports; and
a second apparatus configured to receive a control signal and to actuate said first apparatus in response thereto, in order to effect said attenuation of optical transmissions delivered through at least one of said plurality of output ports.

21. The apparatus according to claim 20, further comprising an optical splitter apparatus configured to multiplex and demultiplex optical transmissions between said first port and said plurality of output ports.

22. The apparatus according to claim 20, wherein said control signal is received via said incoming optic fiber.

23. The apparatus according to claim 20, wherein said control signal is received via an external wired or wireless communications channel.

24. The apparatus according to claim 20, wherein:
said optical transmissions comprise a plurality of frequency bands; and
said attenuation comprises energy reduction of said optical transmissions within at least one of said plurality of frequency bands.

25. A method of selectively providing service to a plurality of subscribers of a content delivery network, said network comprising an optical conduit, said method comprising:
delivering optical transmissions over said optical conduit, said optical conduit having an apparatus associated therewith, said apparatus being configured to selectively attenuate at least a portion of said optical transmissions;
receiving a control signal at said apparatus; and
actuating, in response to said receiving said control signal, said apparatus in order to selectively attenuate optical transmissions in said optical conduit downstream from said apparatus.

26. The method of claim 25, wherein said control signal is received via said conduit.

27. The method of claim 25, wherein said control signal is received via an external wired or wireless communications channel.

28. The method of claim 25, wherein said selective attenuation is achieved by imposing a plurality of bends in said optical conduit.

29. The method of claim 25, wherein
said optical transmissions comprise a plurality of frequency bands, and
said attenuation comprises energy reduction of said optical transmissions within at least one of said plurality of frequency bands.

30. An optical switching apparatus, comprising:
first apparatus comprising at least first and second ends and configured to route an optical conduit from said first end to said second end; and
at least one movable component configured to move within said first apparatus in at least one dimension;
wherein said moveable component is further configured to impose at least one bend in said optical conduit when the component is moved from a first position to a second position, thereby inducing macrobending of said conduit and achieving said optical switching.

31. The apparatus of claim 30, wherein said first apparatus comprises first and second substantially planar surfaces each having at least one complementary undulation formed therein, and said at least one moveable component causes said at least one of said surfaces to move relative to the other, said movement causing said complementary undulations to induce said macrobending within said conduit.

32. Apparatus for selectively switching off optical signals delivered over an optical fiber, comprising:
first apparatus configured to selectively induce chromatic dispersion within said fiber so as to switch off only those signals delivered to a first subset of receivers that are each disposed more than a first optical distance from the apparatus; and
second apparatus configured to selectively induce attenuation of one or more frequency bands carried within said fiber so as to switch off signals delivered to both said first subset of receivers, and a second subset of receivers that are each disposed less than said first optical distance from said apparatus.
